(19) United States
(12) Patent Application Publication
(10) Pub. No.: US 2014/0034564 A1
(43) Pub. Date: Feb. 6, 2014

(54) MULTI-COMPONENT FILTER MEDIA WITH CONTROL RELEASED ADDITIVES

(71) Applicant: CUMMINS FILTRATION IP, INC., Minneapolis, MN (US)

(72) Inventors: Soondeuk Jeung, Cookeville, TN (US); Harold Martin, Cookeville, TN (US); William Haberkamp, Cookeville, TN (US)

(73) Assignee: CUMMINS FILTRATION IP, INC., Minneapolis, MN (US)

(21) Appl. No.: 13/959,915

(22) Filed: Aug. 6, 2013

Related U.S. Application Data
(60) Provisional application No. 61/679,863, filed on Aug. 6, 2012.

(51) Int. Cl. B01D 35/00

(52) U.S. Cl. CPC B01D 35/005
USPC 210/209; 428/378

(57) ABSTRACT

A filter media is described that employs multicomponent fiber material to form the filter media. The multicomponent fiber material is composed of two or more materials at least one of which is soluable in the application fluid that flows through and is filtered by the filter media to release additive(s) in a controlled manner into the application fluid. The additive(s) releases slowly throughout the filter application life.

### FIELD

A filter media is described that uses multicomponent fiber material to form the filter media, the multicomponent fiber material is composed of two or more materials at least one of which is soluble in the application fluid to release additive(s) in a controlled manner into the application fluid.

### BACKGROUND

The release of liquid additives within a filter assembly to modify a characteristic of an application fluid flowing through the filter assembly has been previously achieved using liquid canisters or small solid blocks inside of the filter housing. One example is described in U.S. Pat. No. 6,238,554. Depending upon the application, these known techniques may limit the space available to support the interior of the filter media, may require an extra element, such as a screen, to contain additive blocks, and decrease the velocity of fluid flowing through the filter.

U.S. Pat. No. 4,065,555 discloses the slow release of a biocide from a polymer material in a pesticide application.

### SUMMARY

A filter media is described that employs multicomponent fiber material to form the filter media. The multicomponent fiber material is composed of two or more materials at least one of which is soluble in the application liquid that flows through and is filtered by the filter media to release additive(s) in a controlled manner into the application liquid. The additive(s) releases slowly throughout the filter application life. The solubility varies based on a number of factors, such as the application liquid and the desired end use of the filter media.

The idea of adding one or more additive(s) directly within the fibers of the filter media promotes continuous release of the additive(s) from the fibers that dissolve into the application liquid to modify or enhance the performance of the application liquid or downstream components exposed to the application liquid. The additive(s) can address issues including, but not limited to, microbial contamination, deposit formation, system corrosion, excessive wear from poor lubricity fuels, shortened filter life, and poor combustion efficiency. The additive(s) can provide benefits such as anticorrosion of major internal combustion parts, lubrication in current ultra-low sulfur diesel fuel, enhanced cold starts, and removal and prevention of microbial contamination in diesel engine applications that is usually caused by water.

Additives can include, but are not limited to, demulsifiers, detergents, dispersants, oxidation inhibitors, cetane improvers, fuel borne catalysts, metal deactivators, individually or in any combination thereof. In one embodiment, the additives require small ppm levels (5-30 ppm) to provide performance benefits throughout the service life of the filter that employs the filter media.

In one embodiment, a filter media is provided that has fibers comprising two or more components, and one of fiber components comprises an additive(s) that slowly release into the application liquid.

By adding the additive(s) directly into the filter media fibers so they are released in a controlled fashion throughout the service interval of the filter, they will provide consistent benefits for the internal combustion device or other devices that are exposed to the application liquid, with a minimally variable range of concentration of additive(s) present. In contrast, commercial bottle additives have a large range of variability depending on timing of addition and consistency of release.

The release rate of the additive(s) can be controlled using, for example, the molecular weight of the additive material, the dissolution rate of the additive material, and the basis weight of the total additive(s) in the multicomponent fiber.

A multicomponent fiber as used herein is defined as a fiber or fiber-like material having at least two components. One component can be referred to as a base component that is not designed to be soluble in the application liquid, but instead remains substantially intact throughout the intended service life of the filter media formed wholly or partially from a plurality of the multicomponent fibers. One or more components can be referred to as soluble component(s) that are initially attached to or integrally formed with the base component, and form with the base component the multicomponent fiber. The soluble component(s) is designed to be soluble so as to slow release into the application liquid over the intended life of the filter media. In the case of multiple additives, each additive can be a separate soluble component separate from the other additive(s), or the additives can form a mixture that forms a single soluble component of the fiber.

The multicomponent fiber can take on any form one finds suitable for use in forming filter media. In one embodiment, the multicomponent fiber is a bi-component fiber. Examples of potentially suitable bi-component forms are illustrated in FIG. 1 which shows known bicomponent fiber forms. However, other forms are possible and forms other than those shown in FIG. 1 can be used in the case of multicomponent fibers having more than two components.

The soluble component can be blended in a manner described in U.S. Pat. No. 4,065,555, which is incorporated herein by reference in its entirety, and then applied to the base component at a position so that the soluble component is contacted by the application liquid.

An example of producing a multicomponent fiber in an “islands-in-the-sea” configuration is described in US 2011/0318986 which is incorporated herein by reference in its entirety.

The multicomponent fibers described herein can be used with any application liquid to which one may want to introduce an additive into the application fluid as the fluid flow past the fibers. Examples of application fluids includes, but are not limited to, oil, hydrocarbon based fuels such as diesel fuel, coolant, and hydraulic fluid.

### DRAWINGS

FIG. 1 illustrates known bicomponent fiber forms that can be used.

FIG. 2 schematically depicts the concept of bicomponent fibers with a soluble component described herein releasing additive(s) into an application liquid as the application liquid flows past the fibers.

FIG. 3 is a Fourier Transform Infrared plot of an exemplary dissoluble material in ultra-low sulfur diesel.

### DETAILED DESCRIPTION

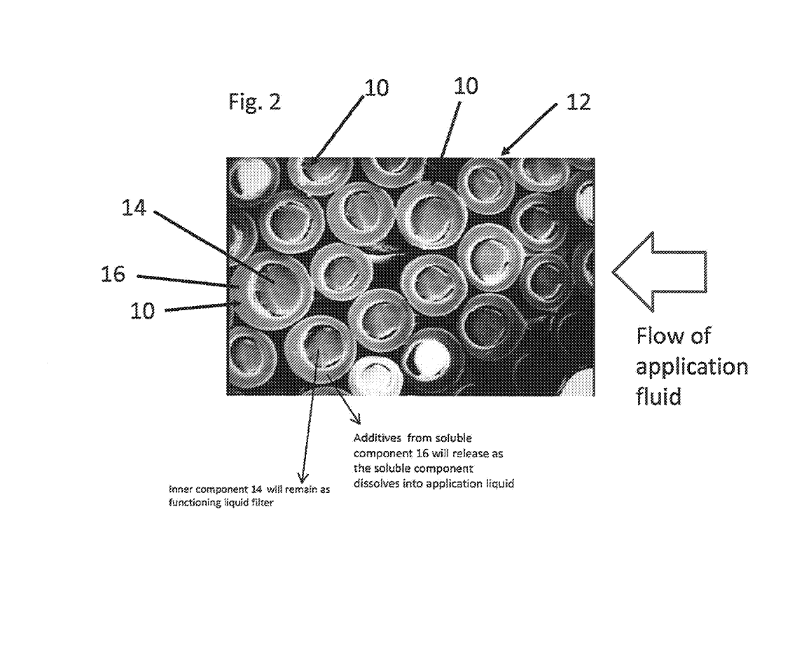

FIG. 2 is a magnified view in cross-section of a plurality of multicomponent fibers 10 that form a filter media 12. The filter media 12 is formed wholly or partially from a plurality of the multicomponent fibers 10. An application liquid flows past the fibers 10, primarily in the direction of the arrow shown in FIG. 2 perpendicular to the axial length of the fibers. However, the liquid can flow in any direction past the fibers 10 as long as the liquid contacts the fibers.

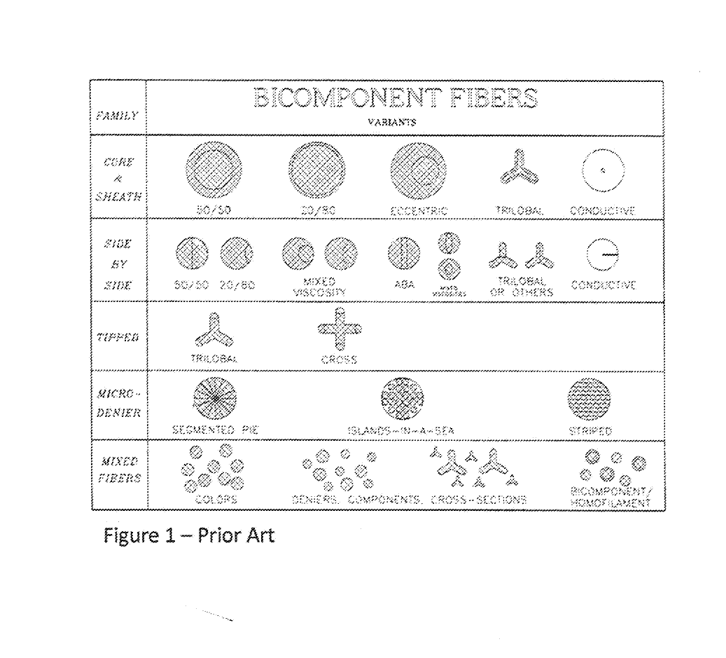

The example illustrated in FIG. 2 shows the fibers 10 as being bicomponent fibers with a non-soluble base component 14 or inner core and a soluble component 16 or outer layer. However, the use of bicomponent fibers is exemplary only. Other multicomponent fibers (e.g. 3 components, 4 components, etc.) can be used. FIG. 1 illustrates other possible multicomponent fiber configurations, but many others not illustrated in FIG. 1 are also possible.

The base component 14 has a fiber form (i.e. a slender structure having a length that is much greater than its transverse dimension). The base component 14 is not designed to be entirely soluble in the application liquid, but instead remains substantially intact throughout the intended service life of the filter media 12 and retains its fiber form to the intended end of service life of the filter media 12. However, it is possible that the base component 14 could include a soluble additive as long as the base component 14 substantially retains the fiber form of the fiber 10.

The soluble component 16 is designed to be soluble in the application fluid so as to slow release into the application liquid over the intended life of the filter media 12. As the application liquid flows through and is filtered by the filter media, the application liquid contacts the fibers 10 causing the soluble component 16 to slowly dissolve to release additive(s) in a controlled manner into the application liquid. The soluble component 16 can be formed from a single additive or from multiple additives. In the case of multiple additives, each additive can be a separate soluble component separate from the other additive(s), or the additives can form a mixture that forms the single soluble component 16.

In one exemplary application involving diesel fuel filter media that filters diesel fuel as the application liquid, the soluble component can be composed of a polyolefin that will dissolve in hydrocarbon fuel liquid. The polyolefin can be mixed with one or more additives intended to modify or enhance the performance of the diesel fuel or downstream components, such as fuel injectors, that use the diesel fuel. As the polyolefin slowly dissolves when the fuel flows through a fiber media, the additive(s) will be released into the diesel fuel. The rate of release can be adjusted to the solubility of the polyolefin to the hydrocarbon diesel fuel. This application of multicomponent fiber media can be extended to various polymer resins depending on final application liquids to be employed.

The soluble component can be varied depending on the application type. The soluble component can be, for example, an oil-soluble polymer like an alkyl styrene or an aromatic hydrocarbon like polystyrene. In the case of diesel fuel and oil, the soluble component can be, for example, polyolefins like polyethylene, polypropylene and other alkyls containing an unsaturated carbon-carbon double bond, homopolymers and copolymers of alkyl methacrylates, alkyl acrylates, and alkyl styrenes. In the case of coolant fluid, soluble materials including, but not limited to, polyakylene oxide, water soluble polymers and hydrophilic polymer can be used.

The term “additive” or the like is intended to encompass a chemical material that may be introduced into a working liquid for treating or enhancing the working liquid or a downstream mechanical component that is contacted by the working liquid.

In the case of the filter media being used to filter fuel such as diesel fuel, examples of additives can include, but are not limited to, lubricity enhancing agents, dispersants, detergents, cetane improvers, flow improvers, fuel burning catalysts, corrosion inhibitors, deicers, power point suppressants, antioxidants, conductivity improvers, microbicides, and suitable combinations thereof

Exemplary fuel additives (diesel, gasoline, jet fuel) can include, but are not limited to, the following:
Conductivity improvers: dimethylsiloxane (preferably 10 ppm or lower)
Cetane number improver: 2-ethylhxyl nitrate (EHN), octyl nitrate, di-tertiary butyl peroxide (DTBP), alkyl nitrate, ether nitrates, peroxide, nitro compounds
Injector cleanliness additives (preferably 50 to 300 ppm): Detergent types
Lubricity additives: mono acids (preferably 10 to 50 ppm), amides, and esters (preferably 50 to 250 ppm)
Smoke Suppressants: barium organometallics or iron, cerium or platinum organometallics
Antifoam Additives: organosilicone compounds (preferably 10 ppm or lower)
De-icing additives: low molecular weight alcohols or glycols
Anti-oxidants: Hindered phenols and certain amines such as phenylenediamine (preferably 10 to 80 ppm)
Drag Reducing Additives (preferably below 15 ppm)
Stabilizer: N, N-dimethylcyclohexyl amine (preferably 50 to 150 ppm)
Metal Deactivator: N, N-disalicylidene-1,2-propane diamine (DMD) (preferably 1 to 15 ppm)
Biocides: phosphorous (preferably 200 to 600 ppm)
Dispersants (preferably 15 to 100 ppm)

In the case of the filter media being used to filter oil, examples of additives can include, but are not limited to, one or more of agents replenishing reserve alkalinity (RA), agents reducing oxidation and wear, agents stabilizing oil viscosity, and/or agents neutralizing acids in the oil, and combinations thereof.

Exemplary oil additives can include, but are not limited to, the following:

| | | | Min | Max |
|---|---|---|---|---|
| Additive | Benefit | Example Chemical Structure | % | % |
| Over-Based | Boost base | Metal sulfonates | 0 | 100 |
| Detergent | number and | Phenols | | |
| | neutralizes | Metal salicylates | | |
| | acids | Metal olenates | | |
| Weak Base | Neutralizes | Metal oxides | 0 | 100 |
| | weak acids | Methyl amine/primary amine | | |
| | | Primary, secondary and tertiary amines | | |
| | | Hindered secondary and tertiary amines | | |
| | | Calcium or magnesium carbonate | | |
| Anti-Oxidant | Reduces the | Zinc dithiophosphates (ZDDP) | 0 | 10 |
| | rate of | Dialkyl di phenyl amine | | |
| | oxidation | N-phenyl-a napthylamine | | |
| | or thermal | Molybdenum dithiocarbamate | | |
| | degredation | Hindered phenols | | |
| | | Alkylated di phenol amines | | |
| | | Aromatic amines | | |
| Anti-Wear/ | Produces a | ZDDP | 0 | 10 |
| Extreme | boundary film | Sulfurized Olefins | | |
| Pressure | on metal | Borate esters | | |
| Agents | surfaces for | Tri-cresyl phosphate | | |
| | protection | Sulfurized fats | | |
| | | Sulfides and disulfides | | |
| Friction | Reduces friction | Oleic acid | 0 | 40 |
| Modifier | between surfaces | Dioleyl phosphite | | |
| | and reduces | Glycerol dioleate | | |
| | parasitic losses | Molybdenum disulphide | | |
| | | Parafin waxes and oxidized waxes | | |
| | | Fatty amines, acides, amides, esters | | |
| | | Fatty phosphates | | |
| | | Nano friction modifier (i.e. | | |
| | | tungstan nano particles) | | |
| | | Poly tetrafluoride | | |
| Dispersant/ | Suspends particles | Succimides | 0 | 10 |
| Viscosity | in the lubricant | Manniches | | |
| Modifier | and boost high | Amides | | |
| | temperature | Olefin copolymers | | |
| | viscosity | Polyisobutly succinimide (PIBSA) | | |
| | | Polyvinylimidizole | | |
| | | Polymethacrylates | | |
| | | Styrene butadiene copolymer (Star | | |
| | | Polymer) | | |
| Anti-Foam | Prevents excessive | Polysiloxane | 0 | 5 |
| | foaming in | Poly ethylene glycol | | |
| | the oil | Poly propylene glycol | | |
| | | Ethylene-propylene copolymers | | |
| Nano | Improved | Over-based nano detergents | 0 | 100 |
| Additives | performance due to | (calcites, etc) | | |
| | increased surface | | | |
| | area | | | |
| Corrosion | prevents corrosion | Succinates | 0 | 5 |
| Inhibitors | and protects | Imidazoline | | |
| | surfaces | Phosphate | | |
| | | Sulfonate | | |
| | | Borate esters | | |
| | | Thiadiazoles | | |
| | | Calcinates | | |
| | | Borate esters | | |
| | | Terephthalic acid | | |
| Pour Point | Lowers the pour | Polyalkyl methacrylate | 0 | 10 |
| Depressants | point of the | Styrene ester | | |
| | lubricant | Poly vinyl acetate - alky fumarate | | |
| | for cold weather | Alkylene coupled napthalene | | |
| | operation | Coupled alkyphenols | | |
| | | Poly ethylene vinyl acetate | | |
| Surfactants | Disperses water | Sodium dodecyl sulfate | 0 | 10 |
| | in the lubricant | Sodium lauryl sulfate | | |

Exemplary coolant fluid additives can include, but are not limited to, one or more of the following: Benzoic Acid, Adipic Acid, Sebacic Acid, Nitrite, Nitrate, Silicate, Molybdate, Phosphate, and Borate, and combinations thereof.

### EXAMPLE 1

The following example is illustrative of a dissoluble material that can be used as a carrier material for one or more additives in a multicomponent fiber described herein.

Polystyrene samples were purchased from ACROS Chemicals with an average molecular weight 250,000. The polystyrene was extruded using a capillary rheometer at 200° C. and cooled and chopped into small pellets. 1.3 weight % of the polystyrene pellets were added to ultra low sulfur diesel (ULSD) and heated to 130° C. by stirring with a magnetic bar on a hot plate.

Thereafter, 10 ml of the diesel solution was sampled 4 times chronologically on the first day and twice per day for subsequent days. 16 of the collected fuel samples were examined under Fourier Transform Infrared (FTIR) (Perkin Elmer) for monitoring polystyrene concentration in the ULSD fuel samples.

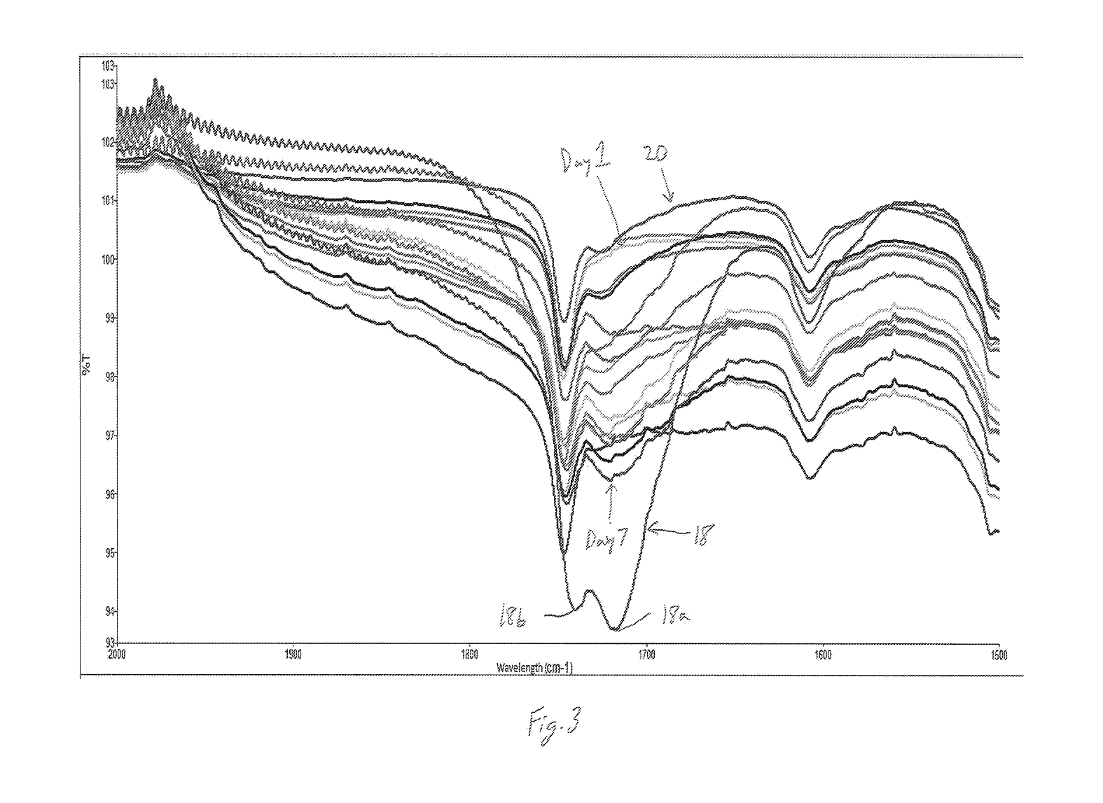

FIG. 3 is a Fourier Transform Infrared plot of the transmittance peak ranging from 1530 cm⁻¹ to 1890 cm⁻¹ focused on polystyrene peak in the ULSD fuel samples from day 1 to day 7. The vertical axis represents the percent transmittance and the horizontal axis represents wavelength. Neat (i.e. by itself with no additive(s)) polystyrene is shown by the line 18 and has one distinctive split peak 18a at about 1720 cm⁻¹ and another peak 18b at about 1740 cm⁻¹. ULSD fuel by itself (without polystyrene added) is shown by the line 20. The remaining lines show plots of the various fuel samples taken during day 1 to day 7, with day 1 samples starting close to the line 20 and progressing downward to the day 7 samples.

The results show that the day 1 ULSD solution shows little or no signs of polystyrene in the ULSD samples due to the lack of a peak at about 1720 cm⁻¹. One distinctive polystyrene peak appears at the end of day 1 at about 1720 cm^{-l} and keeps getting larger as the days pass until the end of day 7.

These results demonstrate that polystyrene can be a good candidate to be used as a soluble carrier component for the additive(s) in the multicomponent fiber.

### EXAMPLE 2

Table 1 below provides an example of a filter media, basis weight, and fuel consumption that can be used to result in a suitable additive concentration in ULSD. In this example, the additive concentration is assumed to be about 228 ppm which is an adequate concentration level for most diesel fuel additives.

This example assumes that the multicomponent fiber is of a sheath/core construction, with the sheath part of the fiber being dissoluble and up to 50 weight % polymer material utilized to fiber area. The maximum additive amount can be up to 50 weight % of the sheath part. So in one example, if the sheath is a total of about 52 grams, there is about 26 gram of additive in the sheath.

According to Table 1 below, the total ULSD fuel consumption during the service period is about 90,000 liter with regulated flow rate of fuel.

TABLE 1
Example filter media, basis weight and fuel data.

| | | |
|---|---|---|
| Numbers of Pleats | 68 | |
| Pleat Area | 0.455 | m² |
| Basis Weight for Filter Media | 230 | Gsm |
| Polymer Weight | 104.68 | g per filter |
| flow rate of fuel | 3 | l/min |
| service hours | 500 | Hrs |
| total fuel for service period | 90000 | Liter |

An additive concentration of about 228 ppm is very feasible based on the use of polystyrene described above in Example 1. To increase the release rate, low molecular weight polystyrene can be used, and to increase additive amount a higher basis weight filter media can be used.

It will be appreciated that other additive varieties may be employed in other filtration applications. Such additives include those additives as typically known and used in other working liquids, for example, hydraulic and coolant liquid types. Thus, a variety of additives may be employed depending on the desired filtration application. The additive is not limited to any particular application or purpose, so long as the additive(s) is suitable for working liquid applications, such as for removing or neutralizing undesired contaminants, or for enhancing performance of a working liquid, or otherwise treating a liquid(s) being filtered.

The invention may be embodied in other forms without departing from the spirit or novel characteristics thereof. The embodiments disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A multicomponent fiber, comprising:
a base component having a fiber form; and
a soluble component attached to the base component and that contains an additive.

2. The multicomponent fiber of claim 1, wherein the soluble component is soluble in hydrocarbon based fuel, lubrication oil, coolant or hydraulic fluid.

3. The multicomponent fiber of claim 2, wherein the hydrocarbon based fuel is diesel fuel.

4. The multicomponent fiber of claim 1, wherein the soluble component is arranged on an outer surface of the base component.

5. The multicomponent fiber of claim 1, wherein the additive is selected from the group consisting of a lubricity enhancing agent, a dispersant, a detergent, a cetane improver, a flow improver, a fuel burning catalyst, a corrosion inhibitor, a deicer, a power point suppressant, an antioxidant, a conductivity improver, a microbicide, a smoke suppressant, an antifoam agent, a de-icer, a drag reducer, a stabilizer, a metal deactivator, and combinations thereof.

6. The multicomponent fiber of claim 1, wherein the additive is selected from the group consisting of an over-based detergent, a weak base, an anti-oxidant, an anti-wear agent, a friction modifier, a dispersant, an anti-foam agent, a nano additive, a corrosion inhibitor, a pour point depressant, a surfactant, and combinations thereof.

7. The multicomponent fiber of claim 1, wherein the additive is selected from the group consisting of benzoic acid, adipic acid, sebacic acid, nitrite, nitrate, silicate, molybdate, phosphate, borate, and combinations thereof.

8. The multicomponent fiber of claim 1, wherein the soluble component comprises an alkyl styrene or an aromatic hydrocarbon.

9. The multicomponent fiber of claim 1, wherein the soluble component comprises polystyrene, polyethylene, polypropylene, a homopolymer or copolymer of alkyl methacrylate, an alkyl acrylate, polyakylene oxide, a water soluble polymer, or a hydrophilic polymer.

10. A filter media for filtering an application fluid, comprising:
a plurality of multicomponent fibers arranged to form the filter media, each multicomponent fiber includes:
a base component having a fiber form and that is not soluble in the application fluid over the intended service life of the filter media; and
a soluble component attached to the base component that is soluble in the application fluid, the soluble component contains an additive that is introduced into the application fluid as the soluble component dissolves.

11. The filter media of claim 10, wherein the soluble component is soluble in hydrocarbon based fuel, lubrication oil, coolant or hydraulic fluid.

12. The filter media of claim 11, wherein the hydrocarbon based fuel is diesel fuel.

13. The filter media of claim 10, wherein the soluble component is arranged on an outer surface of the base component.

14. The filter media of claim 10, wherein the additive is selected from the group consisting of a lubricity enhancing agent, a dispersant, a detergent, a cetane improver, a flow improver, a fuel burning catalyst, a corrosion inhibitor, a deicer, a power point suppressant, an antioxidant, a conductivity improver, a microbicide, a smoke suppressant, an antifoam agent, a de-icer, a drag reducer, a stabilizer, a metal deactivator, and combinations thereof.

15. The filter media of claim 10, wherein the additive is selected from the group consisting of an over-based detergent, a weak base, an anti-oxidant, an anti-wear agent, a friction modifier, a dispersant, an anti-foam agent, a nano additive, a corrosion inhibitor, a pour point depressant, a surfactant, and combinations thereof.

16. The filter media of claim 10, wherein the additive is selected from the group consisting of benzoic acid, adipic acid, sebacic acid, nitrite, nitrate, silicate, molybdate, phosphate, borate, and combinations thereof.

17. The filter media of claim 10, wherein the soluble component comprises an alkyl styrene or an aromatic hydrocarbon.

18. The filter media of claim 10, wherein the soluble component comprises polystyrene, polyethylene, polypropylene, a homopolymer or copolymer of alkyl methacrylate, an alkyl acrylate, polyakylene oxide, a water soluble polymer, or a hydrophilic polymer.

19. The filter media of claim 10, wherein the filter media is fuel filter media.

20. The filter media of claim 10, wherein the filter media is oil filter media.
